(19) United States
(12) Patent Application Publication
(10) Pub. No.: US 2024/0419137 A1
(43) Pub. Date: Dec. 19, 2024

(54) COMPUTER-IMPLEMENTED METHOD, DEVICE AND COMPUTER PROGRAM FOR DETERMINING TRAJECTORIES FROM A SET OF TRAJECTORIES FOR MEASUREMENTS ON A TECHNICAL SYSTEM

(71) Applicant: Robert Bosch GmbH, Stuttgart (DE)

(72) Inventors: Mark Schillinger, Ilsfeld (DE); Christoph Zimmer, Stuttgart (DE); Roland Klinnert, Korntal-Muenchingen (DE); Sebastian Gerwinn, Leonberg (DE); The Duy Nguyen-Tuong, Herrenberg (DE)

(21) Appl. No.: 18/700,539

(22) PCT Filed: Oct. 31, 2022
(86) PCT No.: PCT/EP2022/080365

§ 371 Date: Apr. 11, 2024

(30) Foreign Application Priority Data
Nov. 16, 2021 (DE) 10 2021 212 857.2

(51) Int. Cl. G05B 13/04

(52) U.S. Cl. CPC G05B 13/048

(57) ABSTRACT

A computer-implemented method and device for determining trajectories from a set of trajectories for measurements on a technical system. A predictive model of the technical system includes a measure of uncertainty of the prediction of the predictive model, wherein the measure depends on trajectories from the set, wherein the trajectories from the set for which the measure indicates a greater or equal uncertainty than the measure for others of the trajectories from the set are determined.

### FIELD

The present invention relates to a computer-implemented method, a device, and a computer program for determining trajectories for measurements on a technical system.

### BACKGROUND INFORMATION

Measurements may comprise time series data. C. Zimmer, M. Meister, D. Nguyen-Tuong, “Safe Active Learning for Time-Series Modeling with Gaussian Processes,” NIPS 2018 describes an algorithm for dynamic active safe learning for time series data.

### SUMMARY

The computer-implemented method, the device and the computer program according to the present invention allow test planning in a manner that is improved in terms of safety and information gain.

According to an example embodiment of the present invention, the computer-implemented method for determining trajectories from a set of trajectories for measurements on a technical system provides that a predictive model of the technical system comprises a measure of uncertainty of the prediction of the predictive model, wherein the measure depends on trajectories from the set, wherein the trajectories from the set for which the measure indicates a greater or equal uncertainty than the measure for others of the trajectories from the set are determined. As a result, the most informative trajectories for a respective use case are selected from a set of in particular realistic trajectories.

For example, the predictive model comprises a non-linear network mapping its input to its output with a time delay, or a non-linear autoregressive neural network with an exogenous input, or a Gaussian process, or a machine learning model with a predictive covariance. The latter are particularly suitable since they comprise a measure of uncertainty of the prediction.

The measure preferably comprises a determinant of a covariance that depends on trajectories from the set. This measure is computable by a computer that requires reduced computing resources in comparison to other measures.

According to an example embodiment of the present invention, preferably, a measurement is performed on the technical system with at least one of the trajectories. A release test for the technical system is, for example, carried out thereby with at least one of the most informative trajectories.

It may be provided that the predictive model is trained depending on the at least one trajectory and the measurement assigned thereto, on a quality measure that depends thereon. This improves the predictive model.

According to an example embodiment of the present invention, preferably, trajectories are iteratively determined from the set, measurements are carried out with these trajectories, and the predictive model is trained on the quality measure, depending on the trajectories and the measurements assigned thereto. This self-learning behavior determines the most informative trajectories in an automated manner.

According to an example embodiment of the present invention, the technical system is, for example, a computer-controlled machine, in particular a robot, a vehicle, a household appliance, a tool, a manufacturing machine, a personal assistance system, or an access control system.

Through the following measures, the subset of the trajectories is determinable, e.g., in an embedded measurement system, by a computer with low computing resources.

According to an example embodiment of the present invention, it may be provided that a respective index is assigned to the trajectories, wherein the indices of the trajectories for which the measure indicates the greater or equal uncertainty are determined.

According to an example embodiment of the present invention, it may be provided that a number of trajectories are selected from the set, wherein the measure is determined for the number of trajectories.

According to an example embodiment of the present invention, it may be provided that the measure is determined in iterations, wherein, per iteration, a portion of the measure is determined depending on a respective trajectory.

According to an example embodiment of the present invention, it may be provided that measurements with trajectories are performed on the technical system in an order, wherein the order in which the measurements are performed is an order in which the trajectories are determined from the set, or wherein the order in which the measurements are performed is determined depending on the order in which the trajectories are determined from the set.

In addition, according to an example embodiment of the present invention, it may be provided that the most informative trajectories for the respective use case, in the measurement of which damages to the technical system are avoided as much as possible, are selected from the set of in particular realistic trajectories. It may be provided that a subset of trajectories is determined from the set, wherein, for each trajectory from the subset, a probability is determined that the technical system is damaged by a measurement with this trajectory or that the technical system remains undamaged in a measurement with this trajectory, wherein the subset of trajectories is either provided or used for measurement if the probability for each trajectory satisfies a condition or if the probabilities of the trajectories from the subset together satisfy a condition, and wherein the subset of trajectories is otherwise not provided or used for measurement.

The present invention further provides a device for determining trajectories from a set of trajectories for measurements on a technical system is designed to perform the method according to the present invention.

According to an example embodiment of the present invention, the device comprises at least one processor, at least one memory and at least one interface, wherein the at least one processor is designed to perform the method, wherein the at least one memory is designed to store the set of trajectories, the predictive model and/or the trajectories determined from the set, and wherein the interface is designed, for performing and/or for recording measurements on the technical system, to communicate in particular with a test bench for the technical system.

A computer program for determining trajectories from a set of trajectories for measurements on a technical system comprises computer-readable instructions that, when executed by a computer, cause the method according to the present invention to run.

Further advantageous embodiments of the present invention can be taken from the following description and the figures.

### BRIEF DESCRIPTION OF THE DRAWINGS

FIG. 1 shows a schematic representation of a device for determining trajectories from a set of trajectories for measurements on a technical system, according to an example embodiment of the present invention.

FIG. 2 shows steps in a computer-implemented method for determining the trajectories, according to an example embodiment of the present invention.

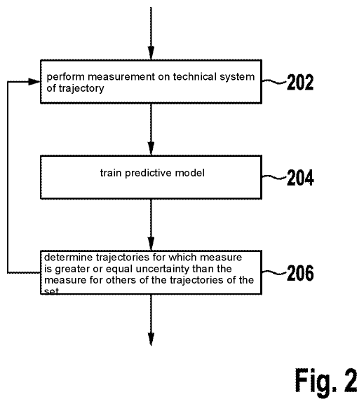

### DETAILED DESCRIPTION OF EXAMPLE EMBODIMENTS

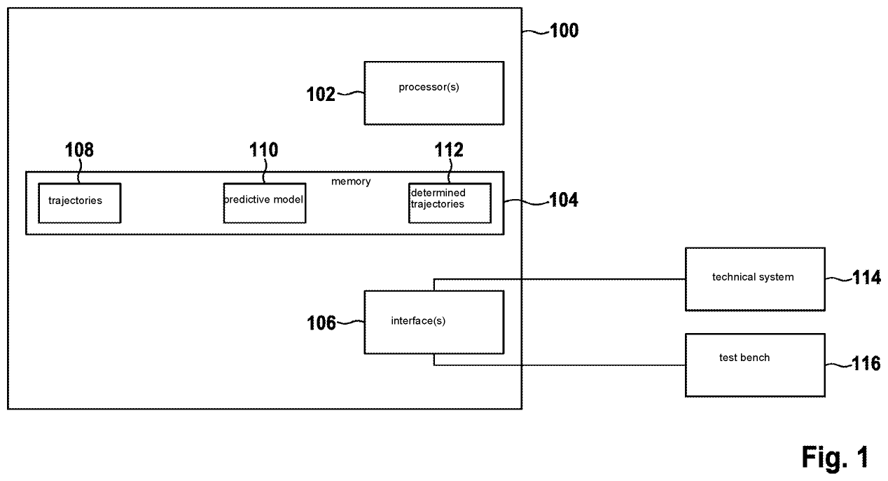

FIG. 1 schematically shows a device 100. The device 100 comprises at least one processor 102, at least one memory 104 and at least one interface 106.

The at least one processor 102 is designed to perform a method described below.

The at least one memory 104 is designed to store a set of trajectories 108, a predictive model 110 and/or trajectories 112 determined from the set.

The interface 106 is designed to communicate for performing and/or for recording measurements on a technical system 114.

The interface 106 in the example is designed to communicate with a test bench 116 for the technical system 114.

The device 100 is, for example, designed to measure one of the trajectories 108, i.e., to perform a measurement with this trajectory. For example, the at least one processor 102 is designed to control the technical system 114 and/or the test bench 116 via the interface 106 to follow this trajectory. For example, the at least one processor 102 is designed to control the technical system 114 and/or the test bench 116 to record a measurement for this trajectory at the interface 106. This measurement comprises, for example, internal data or sensor data of the technical system 114 and/or the test bench 116. The internal data or sensor data are, for example, recorded while this trajectory is followed. The trajectories 108 can each comprise a series of a target variable or of multiple target variables for a behavior, in particular angles, poses, or relative or absolute positions, of the technical system 114 or of a portion of the technical system 114 to one another or relative to an environment of the technical system 114. The measurements can each comprise a series of data of an actual variable or of different actual variables for the behavior, in particular angles, poses, or relative or absolute positions of the technical system 114 or of a portion of the technical system 114. Target variables or actual variables may comprise an internal operating state of the technical system 114 or a portion of the technical system 114.

For example, the technical system 114 is a computer-controlled machine, in particular a robot, a vehicle, a household appliance, a tool, a manufacturing machine, a personal assistance system, or an access control system.

An example of the test bench 116 is an engine test bench designed to test a dynamic behavior of an engine. For example, for the vehicle, a respective measurement is recorded for the trajectories 108 while a driver is driving the respective trajectory with the vehicle. The trajectories 108 may be driven by various drivers and/or various vehicles. For example, in order to develop a new engine for the vehicle or for one of the various vehicles or for a new vehicle, the most informative of these trajectories 108 are tested with the new engine on the engine test bench. Preferably, it is ruled out that the new engine is damaged or destroyed in the process. For example, trajectories in which a temperature of the new engine becomes too high or a rotational speed becomes too large are avoided.

The engine may be a diesel engine, a gasoline engine, an electric motor, or a fuel cell engine. The behavior of the engine relates to a pressure or an exhaust gas, for example.

An example of dynamic learning with the robot relates to learning a dynamic model that maps joint positions for joints that the robot has to joint torques for actuators that the robot has for moving the joints. In dynamic learning, the dynamic model is trained to control the robot. The dynamic learning comprises a search for the trajectories 108 in a search space, for example. In order to avoid damage to the robot, the search space is limited, for example to the joint positions that are in particular mechanically possible. This means that the search space is limited by a limit to the possible joint positions. When searching in the search space, an optimal control of individual or all joints with regard to a cost function is determined, for example. When searching in the search area, a violation of the limit, i.e., damage or destruction of individual or all joints, is preferably avoided.

The dynamic learning is also applicable to trajectories 108 for other actuators. The dynamic learning is also applicable to trajectories 108 and actuators for the vehicle, the household appliance, the tool, the manufacturing machine, and the personal assistance system. The vehicle is, for example, moved partially autonomously along the respective trajectories 108. The household device, the tool or the manufacturing machine is, for example, controlled to produce or change a product by means of a sequence specified by the respective trajectory 108.

The dynamic learning is applicable to trajectories 108 for a virtual sensor. The task is, for example, to learn a dynamic model, i.e., the virtual sensor which replaces a physical sensor. The physical sensor may, for example, be designed to determine a temperature, a torque of an engine, or an amount of carbon dioxide or an amount of nitrogen oxide in an exhaust gas of the engine by measuring the respective physical variable in a measurement range. In the example, the dynamic model is trained on trajectories 108 to determine the physical variable in the measurement range of the sensor. In so doing, the measurement range is limited by a limit so that the training is on trajectories 108 that cannot damage or destroy the engine.

It may also be provided that, for the technical system 114 or the test bench 116, a virtual sensor that replaces a video sensor, radar sensor, LiDAR sensor, ultrasonic sensor or motion sensor therein is learned. For example, the training is on trajectories 108 through which damage or destruction of the technical system 114 is avoided.

A computer program comprising computer-readable instructions that, when executed by a computer, cause the method to run may be provided. In the example, the at least one processor 102 is designed to execute the computer program.

In the example, a set of N trajectories {τi},i ∈{1, . . . ,N} is provided as an input variable of the method.

In the example, a subset of M<N trajectories {τₖ},k ∈K is provided as an output variable of the method, where K ⊂{1, . . . ,N}, and where k denotes the indices of the selected trajectories.

The predictive model 110 has a predictive covariance Σ. The predictive model 110 is, for example, a non-linear network mapping its input to its output with a time delay (NX), or a non-linear autoregressive neural network with an exogenous input (NARX), or a Gaussian process GP, or a machine learning model with a predictive covariance Σ.

The method is described using the example of the GP. The method is also applicable to other predictive models 110.

In the example, the method selects, from the set of the trajectories, those N trajectories that optimize the information with respect to the Gaussian process GP.

The method determines M<N trajectories τⱼ, i.e., a subset of the trajectories that is smaller than a set of the trajectories τₖ from the input variable.

The method provides that an optimization problem is solved.

The optimization problem is based on the covariance Σ{τⱼ},j∈J of the GP with

$$J = {argmax}_{\{ J ⊂ \{ 1 , … , N \} ∧ \vert J \vert = M \}} det ( \sum {\{ {τ}_{j} \}}_{j ∈ J} )$$

This means that the predictive model 110 of the technical system 114 comprises a measure det(Σ{τⱼ}_{j∈J}) of uncertainty of the prediction of the predictive model 110. This means that the measure depends on trajectories from the set. This means that the measure comprises a determinant of the covariance that depends on trajectories from the set.

This means that, from the indices of all trajectories, a subset of indices J is determined that, from the entire set {1, . . . ,N}, determine the indices of the subset of the trajectories that has |J|=M elements and maximizes the determinant of the covariance Σ.

Subsequently, the M trajectories {τⱼ}_{j∈J} are measured and the predictive model 110 is determined depending thereon.

The trajectories are iteratively selected in the example. In the example, for a first iteration, the set of N trajectories {τᵢ},i ∈ {1, . . . ,N} and the subset of M trajectories {τₖ},k ∈ K are specified.

The method comprises a step 202.

In step 202, a measurement is performed on the technical system for at least one trajectory from the subset of M trajectories {τₖ},k ∈ K.

Subsequently, a step 204 is performed.

In step 204, the predictive model 110 is trained depending on the at least one trajectory and the measurement assigned thereto, on a quality measure depending thereon. In the example, the predictive model 110 is trained to predict the measurement for the trajectory as accurately as possible.

Subsequently, a step 206 is performed.

In step 206, the trajectories from the set for which the measure indicates a greater or equal uncertainty than the measure for others of the trajectories from the set are determined.

In the example, an index i is assigned to the trajectories Ti. The indices i of the trajectories for which the measure indicates the greater or equal uncertainty are determined in the example.

In the example, a number M of trajectories {τₖ},k ∈ K is selected from the set and the measure is determined for this number of trajectories.

Steps 202, 204, 206 are repeated in iterations in the example.

This means that trajectories are iteratively determined from the set, measurements are carried out with these trajectories, and the predictive model is trained on the quality measure, depending on the trajectories and the measurements assigned thereto.

The subset of trajectories is, for example, determined gradually in the iterations. For example, per iteration, in particular in step 204, a portion of the measure is determined depending on a respective trajectory.

It may be provided to perform measurements, in particular in step 202, with trajectories on the technical system 114 in an order.

For example, the order in which the measurements are performed, in particular in step 202, is an order in which the trajectories are determined from the set, in particular in step 206. The order is, for example, determined in step 206.

It may be provided to measure the trajectories on the test bench 116 in an order in which they were determined in the iterations. This order reflects an information content. The trajectory determined first, for example, reflects the greatest uncertainty and the greatest information content. In contrast, trajectories that are later in the order have less information content. For example, the trajectory with the greatest information content is measured first in the order, and other trajectories, which are sorted in an order of their information content with decreasing information content, are subsequently measured with decreasing information content.

It may be provided not to measure all trajectories, for example if there are problems when measuring. At least the most informative ones are measured as a result of the order.

It may be provided that, in particular in step 206, a subset of trajectories is determined from the set.

For example, for each trajectory from the subset, a probability is determined that the technical system 114 is damaged by a measurement with this trajectory or that the technical system 114 remains undamaged in a measurement with this trajectory. In this context, remaining undamaged is understood to mean that, for example, no damage that is directly attributable to the measurement with this trajectory occurs to the technical system 114.

In one example, the subset of trajectories is either provided or used for measurement if the probability for each trajectory satisfies a condition.

In one example, the subset of trajectories is either provided or used for measurement if the probabilities of the trajectories from the subset together satisfy a condition.

Otherwise, the subset of trajectories is not provided or used for measurement in the example.

In some technical systems 114, there may be trajectories that are unsafe, i.e., damage the technical system 114. Such trajectories, even if proposed, should not be measured.

In the example, the probability S(τₖ) that a trajectory τₖ is safe is determined. The probability S(τₖ) represents a safety requirement. On the basis of the probability S(τₖ), a condition is checked as to whether the trajectory τₖ is safe or not.

The condition in the example S(τₖ)>α is a condition on the safety. This condition comprises a threshold, in the example a probability α, wherein, if the threshold is exceeded, the trajectory τₖ is safe, otherwise the trajectory is unsafe. For example, a probability α that is greater than a probability α for an unsafe trajectory is assigned to a safe trajectory.

For example, a greater probability is assigned to a trajectory if the measurement thereof only results in a scratch in the technical system 114, and a smaller probability α is on the other hand assigned if the measurement results in the technical system 114 being destroyed, for example. It may be provided that the probability S(τₖ) is or will be provided by a user. It may be provided that the probability S(τₖ) is determined on the basis of previously measured trajectories.

For example, the probability S(τₖ) is learned with a probabilistic machine learning model from previously measured trajectories and a respective probability S(τₖ) specified by the user for them.

If it is, for example, known that a temperature of 100 degrees is critical for the technical system 114, the probabilistic machine learning model is trained to predict, for each trajectory, a temperature that arises when measuring this trajectory. Since the model is probabilistic, the probability S(τₖ) that the temperature is less than 100 degrees is calculated.

In the example, the condition is inserted as a secondary condition into the optimization problem based on the covariance Σ{τⱼ}.

In one example, the subset of trajectories τₖ that solve the optimization problem based on the covariance Σ{τⱼ} is determined, wherein each of the trajectories τₖ by itself satisfies the secondary condition S(τₖ)>α. In this case, the secondary condition for each trajectory τₖ comprises a condition independent of the other trajectories. This subset of trajectories τₖ is determined in particular in step 206. This means that, for each trajectory τₖ, a probability is determined that the technical system 114 is damaged by a measurement of this trajectory τₖ or that the technical system 114 remains undamaged by a measurement of this trajectory. If the secondary condition is satisfied, the trajectory τₖ is provided or used for measurement, and otherwise it is not provided or used for this purpose. In the example, it is provided that a subset of trajectories is first determined and, for the trajectories from this subset, it is then checked whether they respectively satisfy the secondary condition.

In another example, the subset of trajectories τₖ that solve the optimization problem based on the covariance Σ{τⱼ} is determined, wherein the trajectories τₖ together satisfy the secondary condition S(τₖ)>α. In this case, the secondary condition comprises a condition dependent on the trajectories τₖ. This subset of trajectories τₖ is determined in particular in step 206. This means that, for these trajectory τₖ together, a probability is determined that the technical system 114 is damaged by a measurement of this trajectory τₖ or that the technical system 114 remains undamaged by a measurement of this trajectory. If the secondary condition is satisfied, these trajectories τₖ are provided or used for measurement, and otherwise they are not provided or used for this purpose. In the example, it is provided that a subset of trajectories is first determined and, for the trajectories from this subset, it is then checked whether they together satisfy the secondary condition.

The trajectories τₖ are usable as training data for training the predictive model 110 and the probabilistic machine learning model.

1-15. (canceled)

16. A computer-implemented method for determining trajectories from a set of trajectories for measurements on a technical system, wherein a predictive model of the technical system includes a measure of uncertainty of a prediction of the predictive model, wherein the measure depends on trajectories from the set, the method comprising the following steps:
determining trajectories from the set for which a measure of uncertainly indicates a greater or equal uncertainty than a measure of uncertainty for others of the trajectories from the set; and
performing measurements with trajectories from the set on the technical system in an order, wherein: (i) the order in which the measurements are performed is an order in which the trajectories are determined from the set, or (ii) the order in which the measurements are performed is determined depending on the order in which the trajectories are determined from the set.

17. The method according to claim 16, wherein the predictive model includes: (i) a non-linear network mapping its input to its output with a time delay, or (ii) a non-linear autoregressive neural network with an exogenous input, or a Gaussian process, or a machine learning model with a predictive covariance.

18. The method according to claim 16, wherein the measure includes a determinant of a covariance that depends on trajectories from the set.

19. The method according to claim 16, wherein a measurement with at least one of the trajectories is performed on the technical system.

20. The method according to claim 19, wherein the predictive model is trained on a quality measure that depends on the at least one trajectory and the measurement assigned to the at least one trajectory.

21. The method according to claim 20, wherein trajectories are iteratively determined from the set, measurements are carried out with the iteratively determined trajectories, and the predictive model is trained on the quality measure, depending on the trajectories and the measurements assigned to the quality measure.

22. The method according to claim 16, wherein the technical system is a computer-controlled machine, or a robot, or a vehicle, or a household appliance, or a tool, or a manufacturing machine, or a personal assistance system, or an access control system.

23. The method according to claim 16, wherein a respective index is assigned to the trajectories, wherein the indices of the trajectories for which the measure indicates the greater or equal uncertainty are determined.

24. The method according to claim 16, wherein a number of trajectories are selected from the set, wherein the measure is determined for the number of trajectories.

25. The method according to claim 16, wherein the measure is determined in iterations, wherein, per iteration, a portion of the measure is determined depending on a respective trajectory.

26. The method according to claim 16, wherein a subset of trajectories is determined from the set, wherein, for each trajectory from the subset, a probability is determined that the technical system is damaged by a measurement with the trajectory or that the technical system remains undamaged in a measurement with the trajectory, wherein the subset of trajectories is either provided or used for measurement when the probability for each trajectory satisfies a condition or when the probabilities of the trajectories from the subset together satisfy a condition, and wherein the subset of trajectories is otherwise not provided or used for measurement.

27. A device for determining trajectories from a set of trajectories for measurements on a technical system, wherein a predictive model of the technical system includes a measure of uncertainty of a prediction of the predictive model, wherein the measure depends on trajectories from the set, wherein the device is configured to:
determine trajectories from the set for which a measure of uncertainly indicates a greater or equal uncertainty than a measure of uncertainty for others of the trajectories from the set; and
perform measurements with trajectories from the set on the technical system in an order, wherein: (i) the order in which the measurements are performed is an order in which the trajectories are determined from the set, or (ii) the order in which the measurements are performed is determined depending on the order in which the trajectories are determined from the set.

28. The device according to claim 27, wherein the device comprises at least one processor, at least one memory and at least one interface, wherein the at least one processor configured to perform the determination and perform the measurements, wherein the at least one memory is configured to store the set of trajectories, and/or the predictive model, and/or the trajectories determined from the set, and wherein the interface is configured, for performing and/or for recording the measurements on the technical system, to communicate with a test bench for the technical system.

29. A non-transitory computer-readable medium on which is stored a computer program including computer-readable instructions for determining trajectories from a set of trajectories for measurements on a technical system, wherein a predictive model of the technical system includes a measure of uncertainty of a prediction of the predictive model, wherein the measure depends on trajectories from the set, the instructions, when executed by a computer, causing the computer to perform the following steps:
determining trajectories from the set for which a measure of uncertainly indicates a greater or equal uncertainty than a measure of uncertainty for others of the trajectories from the set; and
performing measurements with trajectories from the set on the technical system in an order, wherein: (i) the order in which the measurements are performed is an order in which the trajectories are determined from the set, or (ii) the order in which the measurements are performed is determined depending on the order in which the trajectories are determined from the set.
